(19) United States
(12) Patent Application Publication
(10) Pub. No.: US 2012/0050063 A1
(43) Pub. Date: Mar. 1, 2012

(54) SYSTEM FOR GATHERING AND RECORDING PRODUCTION DATA AND ALLOCATION THEREOF TO A REMOTE DATABASE

(76) Inventors: Benjamin L. Bahorich, Houston, TX (US); Michael S. Bahorich, Houston, TX (US)

(21) Appl. No.: 13/215,343

(22) Filed: Aug. 23, 2011

Related U.S. Application Data
(60) Provisional application No. 61/378,085, filed on Aug. 30, 2010.

(51) Int. Cl. G01V 3/34

(52) U.S. Cl. 340/853.1

(57) ABSTRACT

A wellbore data acquisition and communication system includes a mobile communication and computing device. the device includes at least a data input device, a geodetic position signal receiver and a data communication device. The system includes a remote database having stored thereon information related to specific wellbores. The database is configured to receive the geodetic position of the mobile device and communicate back to the mobile device at least one of previously recorded information pertaining to a specific wellbore and data input fields pertaining to the specific wellbore.

### CROSS-REFERENCE TO RELATED APPLICATIONS

Priority is claimed from U.S. Provisional Application No. 61/378,085 filed on Aug. 30, 2010 and incorporated herein by reference.

### STATEMENT REGARDING FEDERALLY SPONSORED RESEARCH OR DEVELOPMENT

Not applicable.

### BACKGROUND OF THE INVENTION

1. Field of the Invention

The invention relates generally to the field of systems and devices used to read gauges configured to measured fluids produced from wellbores drilled through subsurface rock formations. More specifically, the invention relates to systems and devices for automatically identifying information in a remote database associated with the geodetic location of the gauges and allocating new gauge readings to the appropriate records in the remote database.

2. Background Art

There are currently systems available that use mobile computing devices to gather and manage oil and gas production information. There exists a need for an improved data gathering and management system that improves the speed and quality of information gathering.

### SUMMARY OF THE INVENTION

A wellbore data acquisition and communication system includes a mobile communication and computing device. The device includes at least a data input device, a geodetic position signal receiver and a data communication device. The system includes a remote database having stored thereon information related to specific wellbores. The database is configured to receive the geodetic position of the mobile device and communicate back to the mobile device at least one of previously recorded information pertaining to a specific wellbore and data input fields pertaining to the specific wellbore.

Other aspects and advantages of the invention will be apparent from the following description and the appended claims.

### BRIEF DESCRIPTION OF THE DRAWINGS

FIG. 1 is an example of a remote device used to acquire gauge readings and allocate the reading to correct locations in a remote database.

### DETAILED DESCRIPTION

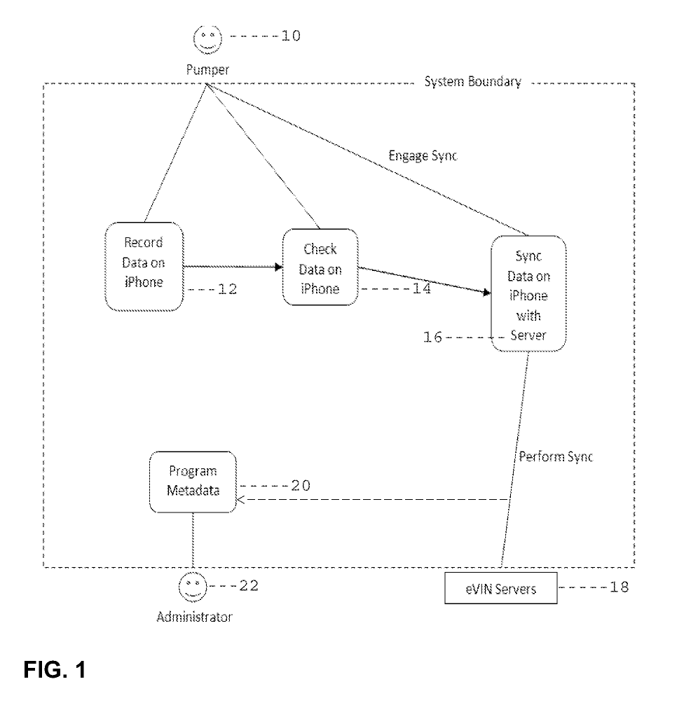

With reference to FIG. 1, a mobile communication and computing device 12 (e.g., one sold under the trademark IPHONE which is a registered trademark of Apple Corporation, Cupertino, Calif., although the invention is not limited to such specific device) may have programmed thereon a set of instructions to enable the user (pumper 10) working proximate one or more producing wellbores to record data related, for example, to the amount of fluid produced by particular wellbores between the most recent prior reading of production gauges and readings made at the time the pumper 10 is present to read the gauges again. The gauges (not shown separately) may include, without limitation, pressure, oil volume, water volume and natural gas volume. The gauge readings may be made by use of the device's 12 internal camera, or may use a local communication protocol, e.g., Bluetooth, or Institute of Electrical and Electronics Engineers (“IEEE”) wireless communication standards 802.11(b), 802.11(g) or 802.11(n) to interrogate gauges having such wireless communication devices connected thereto, and to record information therefrom on the mobile device 12.

The mobile device 12 typically includes a geodetic location signal receiver (e.g.,

GPS). The geodetic location of the device 12 may be transmitted to the well operator's remote database 18. The geodetic position of the device 12 will cause the database 18 to identify which wellbore is being interrogated and to transmit such wellbore information back to the mobile device 12 for use by the pumper 10. Once the proper wellbore information is located in the database 18, the proper data reading form to input tank levels, production information, etc. will be communicated to the mobile communication device 12. Identification of the specific wellbore using the geodetic position information may be used to identify information gathered from the pumper's 10 previous visit to that particular wellbore so that any new information that is entered can be compared (14 in FIG. 1) with what was input during the previous visit. Comparison of present information may prove helpful for quality control of the information entered by the pumper 10 both at the existing time of the information entry and at information entered at any previous time. For example, the mobile device 12 may be programmed to generate graphs that provide a view of selected information over a selected time period to help the pumper 10 determine quality of the input data or any anomalies therein.

The mobile device 12 is typically equipped with an optical camera (not shown separately). The optical camera may be used to obtain images of tags such as nameplates on the well equipment, bar codes, etc., to locate and identify the specific wellbore. Such alternative wellbore identification information may be communicated to the database 18, which will then transmit the proper data input forms and other information for the identified wellbore as described above to the mobile device 12. In some situations, geodetic location information (e.g., GPS) alone may not provide enough resolution to identify the particular wellbore, or may not be available due to terrain limitations, so that using geodetic position information is not practical to cause the database 18 to locate the proper form or previous data or charts. The camera may be used to read a bar code or other type of tag in order to quickly identify the wellbore so that the database 18 can transmit the appropriate forms and prior data entered at that location to the mobile device 12.

The mobile computing device 12 will also typically include a Bluetooth transceiver (not shown separately) and may include a transceiver using one of the IEEE 802.11 communications protocols described above. Such transceiver may be used to automatically synchronize data obtained from the mobile device 12 to a larger, more powerful computing and storage device 16, e.g., a laptop or notebook computer, located, for example, in the pumper's vehicle or truck. Including the Bluetooth or IEEE 802.11 standard transceiver would allow recently input field data to be immediately synchronized with data on the laptop or notebook computer 16. Data stored on the laptop or notebook machine 16 may be transmitted to the oil company remote database (see 18 in FIG. 1) when the laptop or notebook machine 16 has access to a communication link such as satellite or an Internet connection (e.g., wireless broadband or an IEEE 802.11 “hot spot”). This may improve quality control of data input in the field. It should also be noted that in certain cases the mobile device 12 itself may have Internet connectivity from time to time and such synchronization of data between the mobile device 12, laptop or notebook computer 16 and remote database 18 may be performed simultaneously.

The mobile device 12 optical camera may also be used to record maintenance related information. In some situations, an image of a maintenance problem can quickly convey important information to a supervisor at a remote location, or the image may be transmitted to the remote database 18 where an administrator 22 or other database system operator may obtain access to similar images in an image database 20 to help the user to quickly identify the problem. One feature of the present system is to allow camera images to be associated with charts, data tables and graphs that are linked with a specific well or location. The images may, as with all the other data recorded over time, be used to identify visually observable deterioration in wellbore and associated production components, so that a repair or maintenance time may be extrapolated and/or scheduled.

The mobile device 12 also typically includes an audio (voice) recorder (not shown separately). The user (pumper 10) may make statements to be recorded to keep a voice record of maintenance issues. In some situations, it is not practical to write down information or to input alphanumerical data into the mobile device 12. An important feature of the present system is to be able to record the voice of the pumper 10 and have that audio file associated with the specific well or location. The voice record of any irregularities in the wellbore and associated equipment may then be accurately communicated to supervisory or other remotely located personnel, e.g., the administrator 22, for evaluation and recommendation of remedial action as indicated by the voice record and/or images transmitted to the image database 20.

In one example implementation, visual displays of gauges to be interrogated by the mobile device 12 may be converted to rolling number displays to enable the pumper 10 to input information. Currently, the most typical gauge output devices are pointers set to a background scale, which the pumper 10 is required to read by visually interpolating the pointer position with respect to the scale. In the present example, such pointers may be substituted by rolling number displays, which do not require visual interpolation. The use of a rolling number display enables quicker and more accurate input of data. As has been previously stated, gauges may also be used that generate a digital signal readable by the Bluetooth or IEEE 802.11 protocol transceiver, or may generate a barcode or similar output that may be optically input and interpreted by the mobile device 12.

A mobile device and remote database system according to the various aspects of the invention may enable more accurate recording of production and other wellbore data and more timely communication of such data to a remote location, such as the wellbore operator's offices or headquarters such that evaluation by supervisory or expert personnel may be made.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A wellbore data acquisition and communication system, comprising:
a mobile communication and computing device including at least a data input device, a geodetic position signal receiver and a data communication device; and
a remote database having stored thereon information related to specific wellbores, the database configured to receive the geodetic position of the mobile device and communicate back to the mobile device at least one of previously recorded information pertaining to a specific wellbore and data input fields pertaining to the specific wellbore.

2. The system of claim 1 wherein the data input device includes a touch sensitive pad.

3. The system of claim 1 wherein the data input device includes an optical camera.

4. The system of claim 3 wherein the mobile device is configured to interpret images from the optical camera to read bar codes.

5. The system of claim 3 wherein the mobile device is configured to interpret images from the optical camera to rolling number displays.

6. The system of claim 3 wherein previously recorded information pertaining to a specific wellbore includes optical images thereof.

7. The system of claim 3 wherein the remote database includes stored information related to specific wellbores in optical form, the remote database configured to transmit a wellbore identifier to the mobile communication device based on optical images transmitted from the mobile communication device to the remote database.

8. The system of claim 1 wherein the data input device includes an audio recorder.

9. The system of claim 1 wherein the communication device includes at least one of a Bluetooth transceiver or an Institute of Electrical and Electronics Engineers 802.11 protocol transceiver.

10. The system of claim 9 further comprising a portable computer having at least one of a Bluetooth transceiver or an Institute of Electrical and Electronics Engineers 802.11 protocol transceiver, the portable computer configured to receive data from the mobile device and from the remote database.

11. The system of claim 1 wherein the communication device includes an Internet connectivity device.
